(19) United States
(12) Patent Application Publication
(10) Pub. No.: US 2012/0299219 A1
(43) Pub. Date: Nov. 29, 2012

(54) LASER PROCESSING METHOD

(75) Inventors: Hideki Shimoi, Hamamatsu-shi (JP); Keisuke Araki, Hamamatsu-shi (JP); Naoki Uchiyama, Hamamatsu-shi (JP)

(73) Assignee: HAMAMATSU PHOTONICS K.K., Hamamatsu-shi, Shizuoka (JP)

(21) Appl. No.: 13/389,676

(22) PCT Filed: May 27, 2011
(86) PCT No.: PCT/JP2011/062254

§ 371 Date: Feb. 9, 2012

(51) Int. Cl. B29C 35/08

(52) U.S. Cl. 264/400

(57) ABSTRACT

The present invention provides a laser processing method which improves strength and quality of an object to be processed after working. In the present embodiment, after modified regions 7 are formed along the outlines of hollowed-out portions Q1 and Q2 in the object 1 by irradiating the object 1 with a laser light, etching is performed onto the object 1 to selectively advance etching along a fracture which is contained in the modified regions 7 or extend from the modified regions 7, and the hollowed-out portions Q1 and Q2 are spaced and moved from the object 1. Here, the modified regions 7 are formed so as to connect to each other along the outlines of the hollowed-out portions Q1 and Q2, and further exposed on a surface 3 side of the object 1. In this way, in the present embodiment, it is possible to perform working so as to hollow out the hollowed-out portions Q1 and Q2 from the object 1 without applying external stress, and it is possible to remove the fracture generated according to the formation of the modified regions 7 by etching.

### TECHNICAL FIELD

The present invention relates to a laser processing method, and in particular, to a laser processing method in which working is performed so as to hollow out a predetermined portion of an object to be processed.

### BACKGROUND ART

As a conventional laser processing method, a method for irradiating a plate-shaped object with a laser light so as to focus a converging point on the object, to form a modified region inside the object is known (refer to Patent Literature 1, for example). Further, it is designed to partition the object into a plurality of chips from the modified region as a starting point by applying external stress to the object in which a modified region is formed by utilizing such a processing method (refer to Patent Literature 2, for example).

### CITATION LIST

### Patent Literature

Patent Literature 1: Japanese Patent Application Laid-Open No. H4-111800

Patent Literature 2: Japanese Patent Application Laid-Open No. 2004-343008

### SUMMARY OF INVENTION

### Technical Problem

Here, in recent years, in such a laser processing method as described above, working is performed so as to hollow out a predetermined portion of the object by utilizing a modified region formed inside the object in some cases. However, in this case, fracture or breakage may be caused in the object, that may deteriorate the strength and quality of the object after working.

Therefore, an object of the present invention is to provide a laser processing method which is capable of improving the strength and quality of an object to be processed after working.

### Solution to Problem

In order to solve the above-described object, there is provided a laser processing method according to the present invention for working so as to hollow out a predetermined portion of an object to be processed by utilizing a modified region which is formed by converging a laser light inside the object, the method includes a laser light irradiating process of irradiating the object with the laser light, to form the modified region along an outline of the predetermined portion in the object, an etching process of performing etching onto the object after the laser light irradiating process, to selectively advance etching along a fracture which is contained in the modified region or extend from the modified region, and a spacing and moving process of spacing and moving the predetermined portion from the object after the etching process, and in which, in the laser light irradiating process, the modified region is formed so that the fracture is connected along the outline, and the fracture is exposed on an outer surface side of the object.

In the laser processing method, it is possible to perform working so as to hollow out the predetermined portion without applying external stress. Therefore, it is possible to prevent the object from being damaged or deteriorated in strength by application of external stress. Moreover, in the etching process, it is possible to remove fracture generated according to the formation of the modified regions from the object after working. Accordingly, it is possible to improve strength and quality of the object after working by the etching process.

Further, in the laser light irradiating process, it is preferable that a first modified region is formed at a first depth position in a direction of irradiation with the laser light in the object, and thereafter, a second modified region is formed at a second depth position on a laser light irradiation surface side from the first depth position in the object. In this case, it is possible to prevent an effect of the existing first modified region from being exerted on formation of the second modified region, and it is possible to accurately form the second modified region.

Further, it is preferable that the laser light irradiating process includes a first process of repeatedly performing the process of irradiating with the laser light while relatively moving a converging point of the laser light along one direction perpendicular to the direction of irradiation with the laser light, so as to change a depth position of the converging point in the direction of irradiation, and a second process of repeatedly performing the first process so as to change a position of the converging point in the other direction perpendicular to the direction of irradiation and the one direction. In this case, it is possible to shorten a takt time for the laser light irradiating process.

Further, it is preferable that a shape of the outline of the predetermined portion has a taper portion tilted to a direction perpendicular to one surface of the object so as to widen toward the one surface side. In this case, in the spacing and moving process, for example, the predetermined portion is moved so as to be taken out from the one surface side, thereby it is possible to easily space and move the predetermined portion from the object.

### Advantageous Effects of the Invention

In accordance with the present invention, it is possible to improve strength and quality of the object after working.

### BRIEF DESCRIPTION OF DRAWINGS

FIG. 1 is a schematic block diagram of a laser processing apparatus used for forming a modified region.

FIG. 2 is a plan view of an object to be processed targeted to form a modified region therein.

FIG. 3 is a cross-sectional view along the line of the object of FIG. 2.

FIG. 4 is a plan view of the object after laser working.

FIG. 5 is a cross-sectional view along the line V-V of the object of FIG. 4.

FIG. 6 is a cross-sectional view along the line VI-VI of the object of FIG. 4.

FIG. 7 is a table showing examples as an etchant.

FIG. 8A is a plan view showing the object, and FIG. 8B is a side view showing the object of FIG. 8A.

FIG. 9A is a side view showing a laser processing method according to a first embodiment, FIG. 9B is a side view showing a process following the process of FIG. 9A, and FIG. 9C is a side view showing a process following the process of FIG. 9B.

FIG. 10A is a plan view showing a process following the process of FIG. 9C, and FIG. 10B is a side view showing the object of FIG. 10A.

FIG. 11A is a plan view showing a process following the process of FIG. 10, and FIG. 11B is a side view showing the object of FIG. 11A.

FIG. 12A is a plan view showing a process following the process of FIG. 11, FIG. 12B is a side view showing a process following the process of FIG. 12A, and FIG. 12C is a side view showing a process following the process of FIG. 12B.

FIG. 13A is a plan view showing a process following the process of FIG. 12C, and FIG. 13B is a side view showing the object of FIG. 13A.

FIG. 14A is a side view showing a modified example of the first embodiment, FIG. 14B is a side view showing another modified example of the first embodiment, and FIG. 14C is a side view showing yet another modified example of the first embodiment.

FIG. 15A is a side view showing another modified example of the first embodiment, and FIG. 15B is a side view showing a process following the process of FIG. 15A.

FIG. 16 is a side view showing yet another modified example of the first embodiment.

FIG. 17A is a side view showing a laser processing method according to a second embodiment, FIG. 17B is a side view showing a process following the process of FIG. 17A, and FIG. 17C is a side view showing a process following the process of FIG. 17B.

FIG. 18 is a side view showing a process following the process of FIG. 17C.

FIG. 19 is a side view showing a modified example of the second embodiment.

FIG. 20A is a side view showing a laser processing method according to a third embodiment, FIG. 20B is a side view showing a process following the process of FIG. 20A, and FIG. 20C is a side view showing a process following the process of FIG. 20B, and FIG. 20D is a side view showing a process following the process of FIG. 20C.

FIG. 21 is a side view showing a process following the process of FIG. 20D.

FIG. 22A is a side view showing a modified example of the third embodiment, and FIG. 22B is a side view showing another modified example of the third embodiment.

### DESCRIPTION OF EMBODIMENTS

Hereinafter, preferred embodiments of the present invention will be described in detail with reference to the drawings. In addition, the same or corresponding components in the following description are denoted by the same reference numerals and letters, and overlapping descriptions thereof will be omitted.

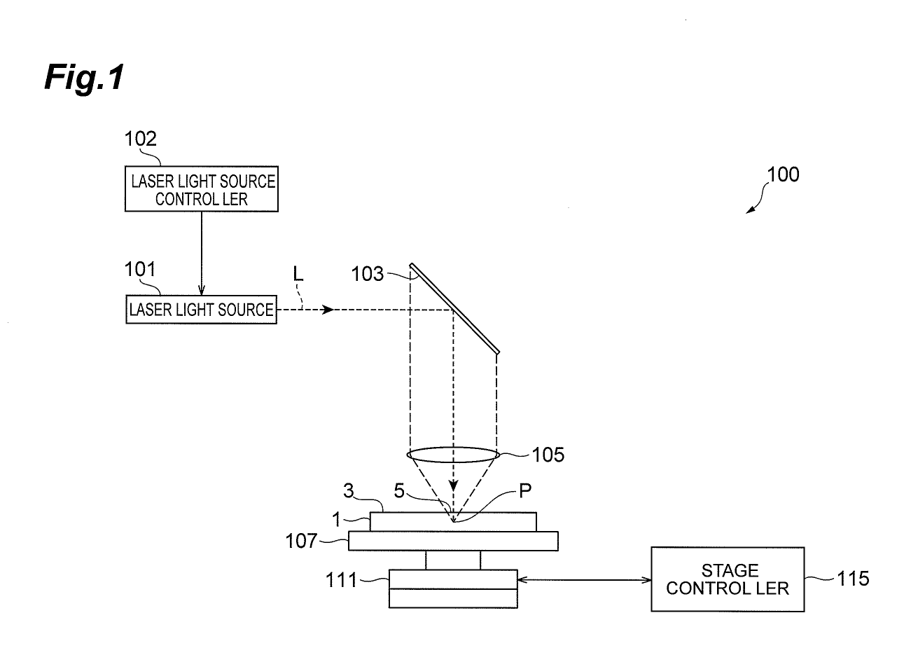

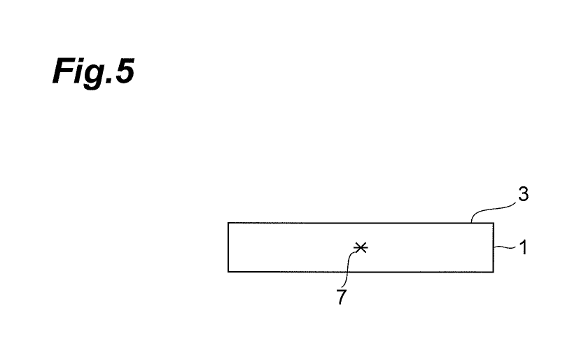

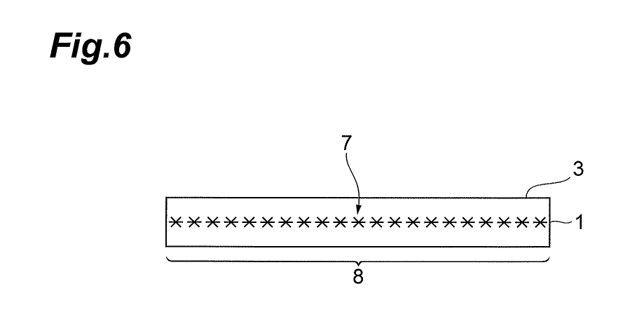

In a laser processing method according to the present invention, working is performed so as to hollow out a predetermined portion of an object to be processed by utilizing a modified region which is formed by converging a laser light inside the object. Then, first, the formation of a modified region will be hereinafter described with reference to FIGS. 1 to 6.

As shown in FIG. 1, a laser processing apparatus 100 is equipped with a laser light source 101 that performs pulsed oscillation of a laser light L, a dichroic mirror 103 which is disposed so as to change the optical axis (optical path) of the laser light L in direction by 90 degrees, and a condenser lens 105 for converging the laser light L. Further, the laser processing apparatus 100 is equipped with a support table 107 for supporting an object to be processed 1 irradiated with the laser light L collected by the condenser lens 105, a stage 111 for moving the support table 107, a laser light source controller 102 that controls the laser light source 101 in order to adjust an output, a pulse width, and the like of the laser light L, and a stage controller 115 that controls the movement of the stage 111.

In this laser processing apparatus 100, the laser light L emitted from the laser light source 101 is changed in direction of its optical axis by 90 degrees by the dichroic mirror 103, and is collected inside the plate-like object 1 placed on the support table 107 by the condenser lens 105. At the same time, the stage 111 is moved, to relatively move the object 1 along a part to form a modified region 5 with respect to the laser light L. Thereby, a modified region along the part 5 is formed in the object 1.

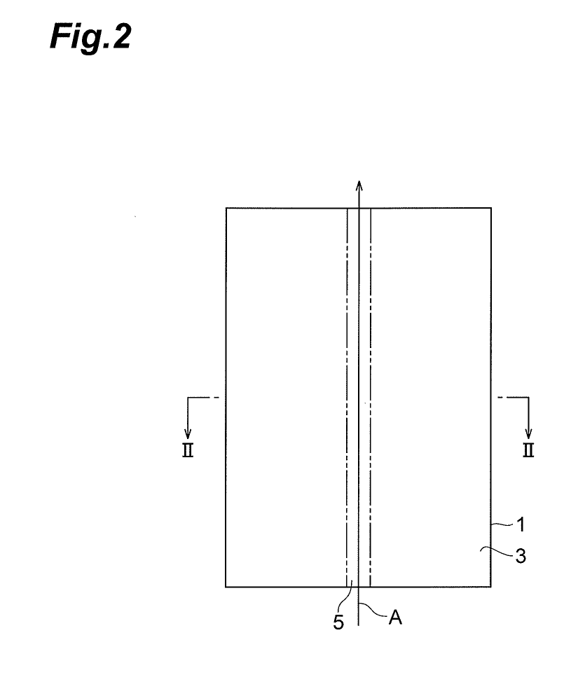

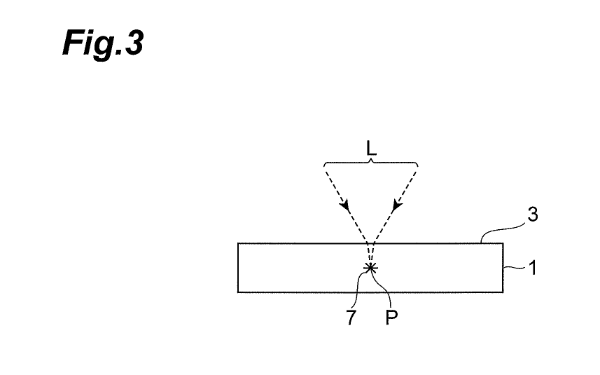

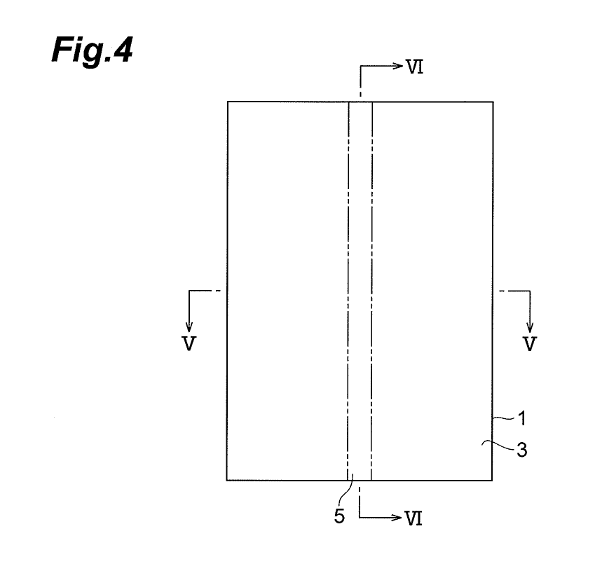

A semiconductor material, a piezoelectric material, or the like may be used as the object 1. As shown in FIG. 2, the part 5 is set in the object 1. Here, the part 5 is a linearly-extended virtual line. In the case where a modified region is formed inside the object 1, as shown in FIG. 3, the laser light L is relatively moved along the part 5 (i.e., in the direction of arrow A in FIG. 2) in a state in which a converging point P is focused on the inside of the object 1. Thereby, as shown in FIGS. 4 to 6, a modified region 7 is formed along the part 5 inside the object 1, and the modified region 7 serves as a removal region 8 by the etching which will be described later.

In addition, the converging point P is a place on which the laser light L is collected. Further, the part 5 is not limited to a linear shape, and may be a curved shape, a curved or planar three dimensional shape, and a shape whose coordinates are specified. Further, the modified region 7 is continuously formed in some cases, and is intermittently formed in some cases. Further, the modified region 7 may be a row form or a point form, that is, it suffices that the modified region 7 is formed at least inside the object 1. Further, a fracture may be formed from the modified region 7 as a starting point in some cases, and the fracture and the modified region 7 may be exposed at the outer surface (the surface, the rear surface, or the outer circumferential surface) of the object 1.

Incidentally, here, the laser light L is made transmissive through the object 1 and is absorbed particularly in the vicinity of the converging point inside the object 1, and thereby forming the modified region 7 in the object 1 (i.e., internal absorption type laser working). Therefore, the laser light L is hardly absorbed into the surface 3 of the object 1, and thus, the surface 3 of the object 1 does not melt in any case. Generally, in the case in which removal portions such as holes, grooves, and the like are melted and removed from the surface 3 to be formed (surface absorption type laser working), a working region gradually advances from the surface 3 side to the rear surface side.

Meanwhile, a modified region formed by the laser processing apparatus according to the present embodiment means a region coming into a state different in density, refractive index, mechanical strength, and other physical characteristics from the circumference thereof. As a modified region, for example, there is a molten processed region, a crack region, a dielectric breakdown region, a refractive index change region, or the like, and there is a region where these are mixed as well. Moreover, as a modified region, there is a region in which the density of a modified region is changed as compared with the density of an unmodified region in a material of the object, or a region in which a lattice defect is formed (these may be collectively called a high-density transitional region).

Further, in some cases, a molten processed region, a refractive index change region, a region in which the density of a modified region is changed as compared with the density of an unmodified region, and a region in which a lattice defect is formed may further contain a fracture (cut or microcrack) inside those regions or in the interface between the modified region and the unmodified region. The fracture to be contained may spread over the entire surface of the modified region or may be formed in only one portion or a plurality of portions in some cases. As the object 1 is, for example, an object consisting of silicon, glass, LiTaO₃, or sapphire (Al₂O₃), or an object composed of those may be cited.

Here, in the present embodiment, after the modified region 7 is formed in the object 1, etching is performed onto the object 1 so as to selectively advance etching along a fracture (called crack, microcrack, break, or the like. Hereinafter, called simply “fracture”) which are contained in the modified region 7 or extend from the modified region 7, to remove a region corresponding to the outline of a predetermined portion (hollowed-out portion) in the object 1.

In detail, in etching of the present embodiment, an etchant is infiltrated into the fracture which is contained in the modified region 7 or extend from the modified region 7 in the object 1, to advance etching along the creviced surface. Thereby, etching is advanced selectively at a high etching rate along the fracture to remove the fracture in the object 1. At the same time, etching is advanced selectively along the modified region 7 as well to remove the modified region 7 by utilizing the feature that the etching rate of the modified region 7 is high.

As etching of the present embodiment, there is a case in which the object is dipped into an etchant (a dipping method: Dipping), and a case in which an etchant is applied to the object while rotating the object (a spin etching method: Spin Etching).

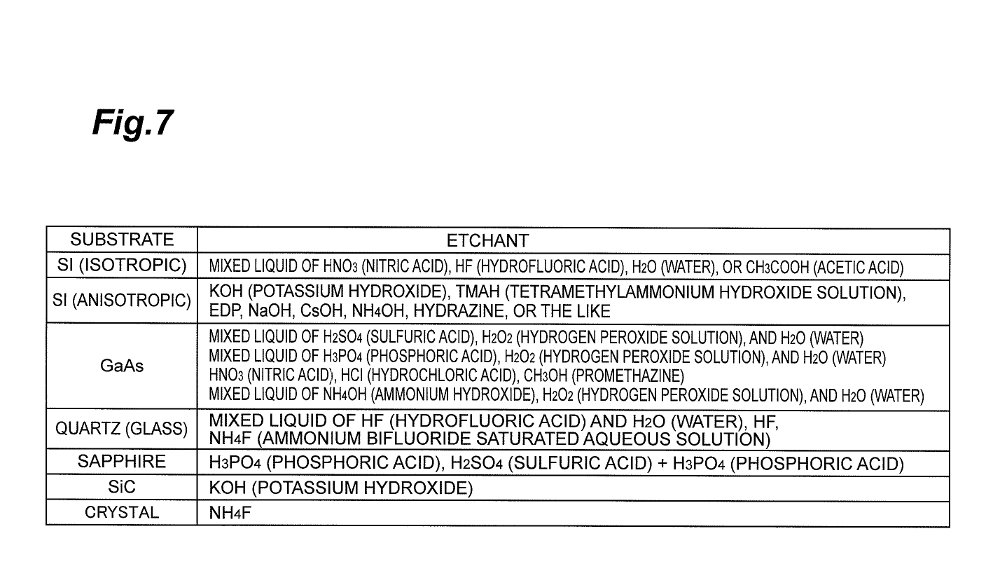

FIG. 7 is a table showing examples as etchant to be used according to materials of substrates. An etchant is used at a temperature from normal temperature to approximately 100 degrees, which is to be set to an appropriate temperature according to a required etching rate and the like. For example, in a case in which etching is performed onto Si (anisotropic) with KOH, a temperature of an etchant is set to approximately 60 degrees, which is preferable. Further, as an etchant, not only a liquid etchant, but also a gel-like (jelly-like, semisolid) etchant may be used.

### First Embodiment

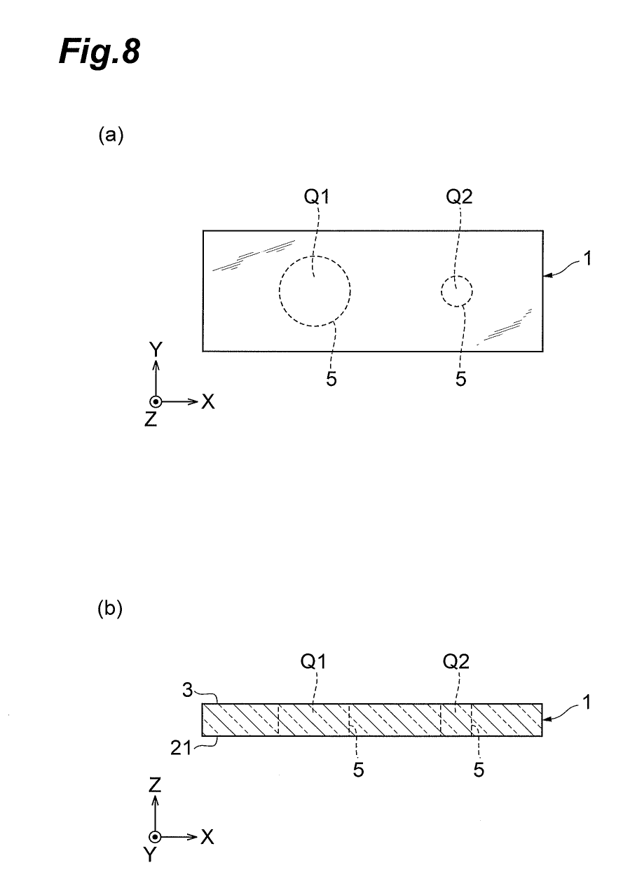

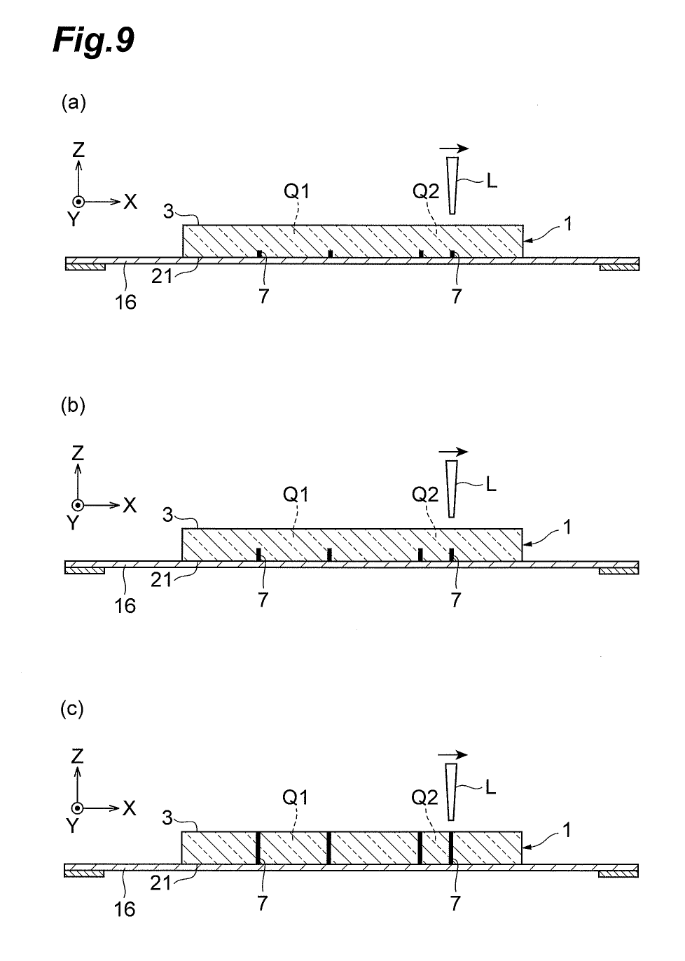

Next, a first embodiment of the present invention will be described in detail. FIGS. 8 are diagrams showing the object serving as an object of a laser processing method according to the present embodiment, and FIGS. 9 to 13 are flow diagrams showing the laser processing method according to the present embodiment.

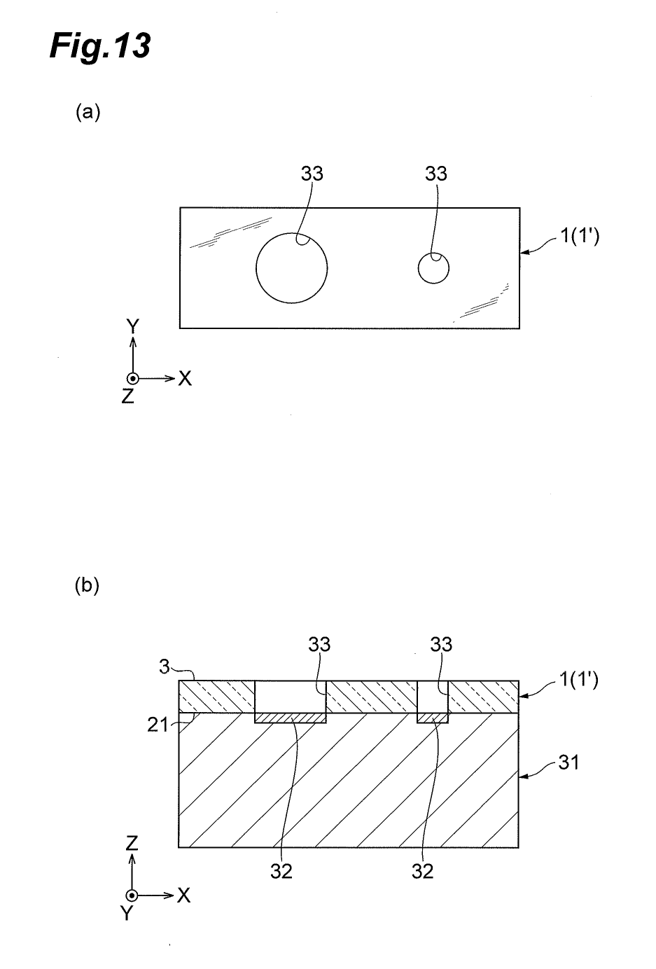

As shown in FIGS. 8 to 13, the present embodiment is a processing method for manufacturing a plate for display or protection to be laminated on a device substrate 31 (refer to FIG. 13), for example. In the present embodiment, working is performed so as to hollow out a plurality of hollowed-out portions Q1 and Q2 in the object 1 in order to expose a device 32 (refer to FIG. 3) of the device substrate 31 to the outside. Here, the hollowed-out portions Q1 and Q2 are column-shaped so as to set its axial direction to the thickness direction of the object 1. A diameter of the hollowed-out portion Q2 is smaller than a diameter of the hollowed-out portion Q1.

In addition, in the following description, the thickness direction of the object 1 (the direction of irradiation with the laser light L) is set as the Z direction, one direction along the surface 3 that is a laser light irradiation surface of the object 1 (direction perpendicular to the direction of irradiation with the laser light L) is set as the X direction, and another direction perpendicular to the X and Z directions (a direction perpendicular to the direction of irradiation with the laser light L and the one direction) is set as the Y direction.

As shown in FIG. 8, the object 1 is a plate-like member transparent to a wavelength of the irradiating laser light L, and a rectangular plate-like glass substrate is used as the object 1 of the present embodiment. Further, here, the parts to form a modified region 5 whose coordinates are specified along the outlines of the hollowed-out portions Q1 and Q2 are provided in three dimensions in the object 1.

In the case where working for the object 1 is performed in the present embodiment, first, as shown in FIG. 9A, a holding tape 16 is stuck on a rear surface 21 of the object 1, and the object 1 is placed on a mount table so that the surface 3 side of the object 1 is set on the upper side.

Next, a converging point of the laser light L (hereinafter, simply called “converging point”) is focused on a Z directional position on the rear surface 21 side of the object 1, and at the same time, this converging point is relatively moved in the X direction. In accordance therewith, ON and OFF irradiation with the laser light L is performed so as to form the modified regions 7 at the part 5 (refer to FIG. 8). In detail, the object 1 is irradiated (ON) with the laser light L when the converging point is focused on the positions of the outlines of the hollowed-out portions Q1 and Q2, and the object 1 is unirradiated (OFF) with the laser light L at other positions.

Thereby, the modified region (first modified region) 7 exposed at the rear surface 21 in the Z directional position (a first depth position) on the rear surface 21 side of the object 1 is intermittently formed along the X direction. In addition, here, because spot-irradiation with a pulse laser light serving as the laser light L is performed, the modified region 7 to be formed is composed of modified spots. Further, the fracture generated from the modified region 7 is inclusively formed in the modified region 7 (that is the same as in the following modified region).

Next, as shown in FIG. 9B, after changing the Z directional position for the converging point being moved to the surface 3 side, ON and OFF irradiation with the laser light L is performed so as to form the modified region 7 at the part 5 while relatively moving the converging point in the X direction. Thereby, the modified region (a second modified region) 7 is newly formed so as to connect to the existing modified region 7 at the Z directional position (a second depth position) on the surface 3 side in comparison to the existing modified region 7. In other words, the modified region 7 is newly formed so that the fracture contained in the modified region 7 and the fracture contained in the existing modified region 7 are connected to each other.

Next, the ON and OFF irradiation with the laser light L described above is repeatedly performed while changing the Z directional position for the converging point in order from the rear surface 21 side to the surface 3 side (the first process). Thereby, as shown in FIG. 9C, the modified regions 7 which extend in the Z direction to connect to each other in the object 1 when viewed from the Y direction are formed along the outlines of the hollowed-out portions Q1 and Q2.

In addition, when the relative movement of the converging point at the time of the ON and OFF irradiation with the laser light L is repeatedly performed in order from the rear surface 21 side to the surface 3 side, it is preferable that the converging point is relatively moved so as to be reciprocated in the X direction in order to shorten a takt time. That is, after performing ON and OFF irradiation with the laser light L while relatively moving the converging point in one direction of the X direction, it is preferable to perform ON and OFF irradiation with the laser light L while relatively moving the converging point in the other direction of the X direction.

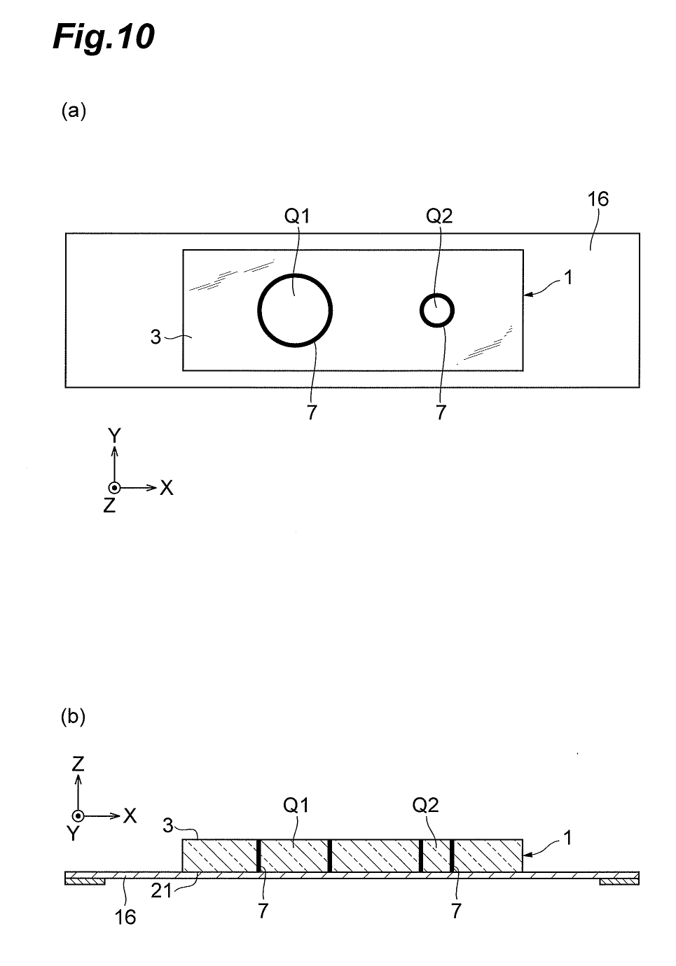

Next, the above-described processes shown in FIGS. 9A to 9C are repeatedly performed while changing the position of the converging point of the laser light L in the Y direction (the second process). As a result, the modified regions 7 which connect to each other on the same X-Y plane inside the object 1 are formed along the outlines of the hollowed-out portions Q1 and Q2. That is, as shown in FIGS. 10, the modified regions 7 connect to each other along the respective side surfaces of the column-shaped hollowed-out portions Q1 and Q2, and are further exposed on the surface 3 side and the rear surface 21 side of the object 1. The modified regions 7 have portions extending along the Z direction when viewed from the Y direction (X direction), and extending so as to draw a curve or a circular arc when viewed from the Z direction.

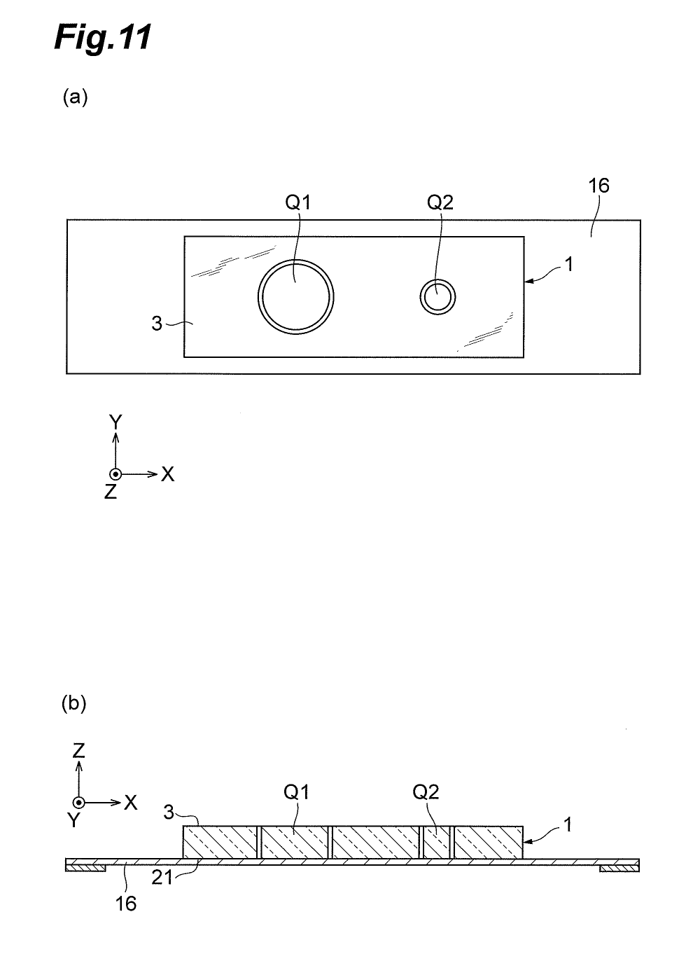

Next, as shown in FIG. 11, etching is performed onto the object 1 in which the modified regions 7 are formed (etching process). In detail, an etchant is infiltrated into the inside from the modified regions 7 exposed at the surface 3 and the rear surface 21, so as to selectively advance etching along the modified regions 7 and the fracture contained in the modified regions 7, to remove the regions corresponding to the outlines of the hollowed-out portions Q1 and Q2 in the object 1.

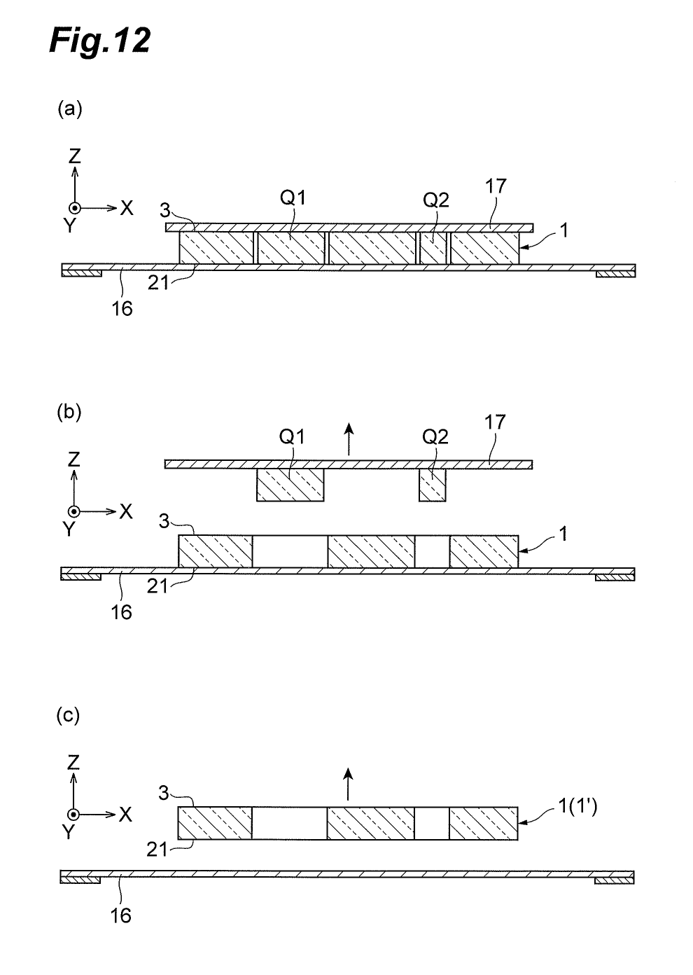

Next, a tape for removing 17 is stuck on the surface 3 of the object 1 as shown in FIG. 12A, and the tape for removing 17 is moved so as to be lifted up as shown in FIG. 12B, thereby the hollowed-out portions Q1 and Q2 are removed (spaced and moved) from the object 1 (spacing and moving process). Finally, the object 1 is removed from the holding tape 16 as shown in FIG. 12C.

In accordance with the above-described processes, working is performed so as to hollow out the hollowed-out portions Q1 and Q2 of the object 1, thereby forming through-holes 33 in the object 1. Thereafter, as shown in FIG. 13, an object to be processed 1′ after working is laminated on the device substrate 31 so as to locate the through-holes 33 on the devices 32 of the device substrate 31.

As described above, in accordance with the present embodiment, it is possible to perform working so as to hollow out the hollowed-out portions Q1 and Q2 from the object 1 without applying external stress. Therefore, it is possible to prevent the object 1 from being damaged or deteriorated in strength by application of external stress. Moreover, because etching is selectively advanced along the modified regions 7 and the fracture contained in the modified regions 7, it is possible to remove the fracture from the object 1′ after working, which makes it possible to improve strength and quality of the object 1′ after working. Further, because dust due to working is not generated as in a cutting work, it is possible to achieve a processing method, which is friendly to the working environment.

Further, in the present embodiment, as described above, after the modified region 7 is formed, the modified region 7 is newly formed on the surface 3 side in comparison to the existing modified region 7. Therefore, it is possible to prevent an effect of the existing modified region 7 from being exerted on the modified region 7 to be newly formed. Therefore, it is possible to accurately form the modified regions 7.

Further, in the present embodiment, as described above, the process of irradiation with the laser light L while relatively moving the converging point along the X direction is repeatedly performed while changing the Z directional position for the converging point (refer to FIGS. 9A to 9C). Then, by repeatedly performing the process shown in FIGS. 9A to 9C while changing the Y directional position for the converging point, the modified regions 7 are formed along the outlines of the hollowed-out portions Q1 and Q2 in the object 1. Therefore, wasted movement of the converging point is reduced, to make fast working possible, which makes it possible to achieve shortening of a takt time (working time), that results in reduction in cost.

Further, in the present embodiment, as described above, because the modified regions 7 formed inside the object 1 by irradiation with the laser light L are utilized, it is possible to perform working so as to freely hollow out the object 1 in three dimensions.

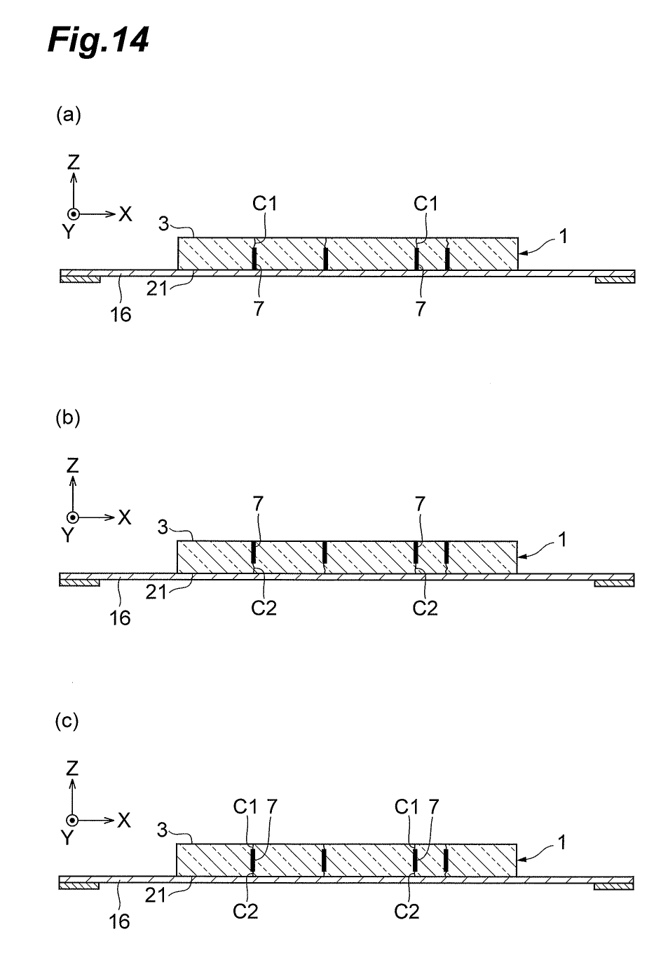

In addition, in the present embodiment, as shown in FIG. 10, the modified regions 7 are exposed on the surface 3 side and the rear surface 21 side of the object 1. However, in place of that, a fracture C1 extending from the modified regions 7 may be exposed on the surface 3 side of the object 1 as shown in FIG. 14A, and a fracture C2 extending from the modified regions 7 may be exposed on the rear surface 21 side of the object 1 as shown in FIG. 14B. Moreover, the fracture C1 and C2 extending from the modified regions 7 may be respectively exposed on the surface 3 side and the rear surface 21 side of the object 1 as shown in FIG. 14C. That is, it suffices that the fracture contained in the modified regions 7 or extending from the modified regions 7 reach the outer surface of the object 1 in order to infiltrate the etchant into the inside at the time of etching.

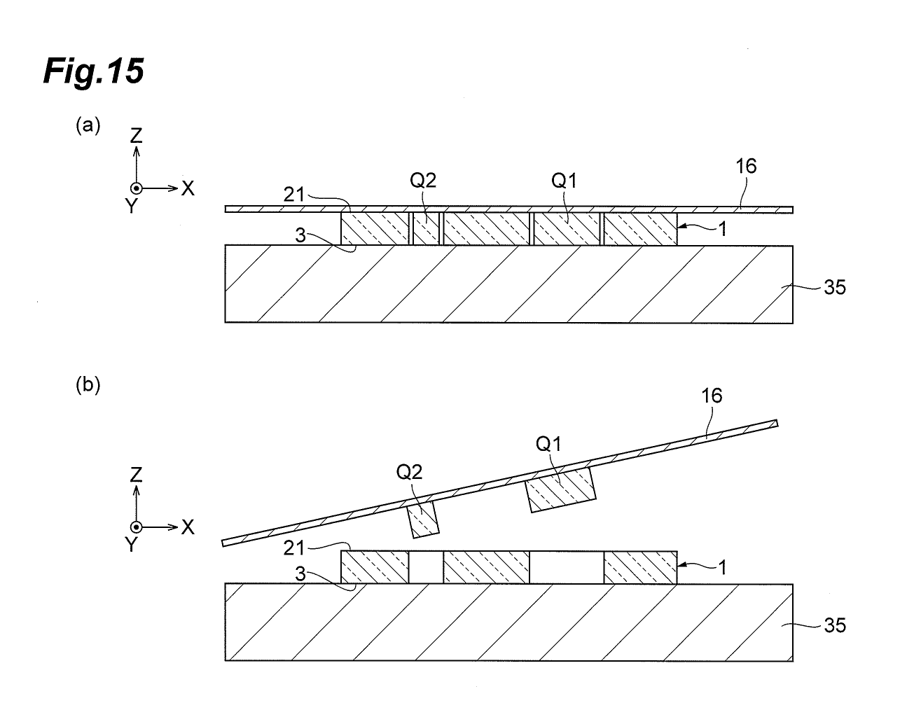

Further, in the present embodiment, as described above, the hollowed-out portions Q1 and Q2 are removed by use of the tape for removing 17 (refer to FIG. 12). However, as shown in FIG. 15, the hollowed-out portions Q1 and Q2 may be removed by use of an air adsorption part 35 such as a porous chuck.

In detail, after performing etching onto the object 1, the object 1 is inversed upside down, and the surface 3 is adsorbed by the air adsorption part 35 as shown in FIG. 15A. Then, the holding tape 16 may be moved so as to be lifted up, to remove the hollowed-out portions Q1 and Q2 from the object 1 as shown in FIG. 15B.

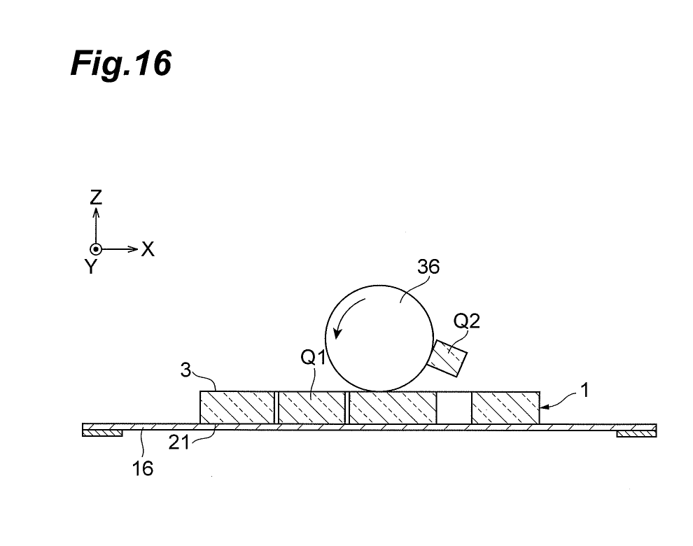

Alternately, after performing etching onto the object 1, the hollowed-out portions Q1 and Q2 may be removed by use of an adhesive roller 36 as shown in FIG. 16.

### Second Embodiment

Next, a second embodiment of the present invention will be described. In addition, in the present embodiment, points different from the first embodiment will be mainly described.

In the present embodiment, working is performed so as to hollow out a plurality of hollowed-out portions Q3 and Q4 in the object 1. Here, the hollowed-out portions Q3 and Q4 are conical trapezoid-shaped with the surface 3 serving as the bottom surface. That is, the hollowed-out portions Q3 and Q4 have taper portions 55 tilted to the Z direction (a direction perpendicular to the surface 3) so as to widen toward the surface 3 (one surface) of the object 1, on their side surfaces.

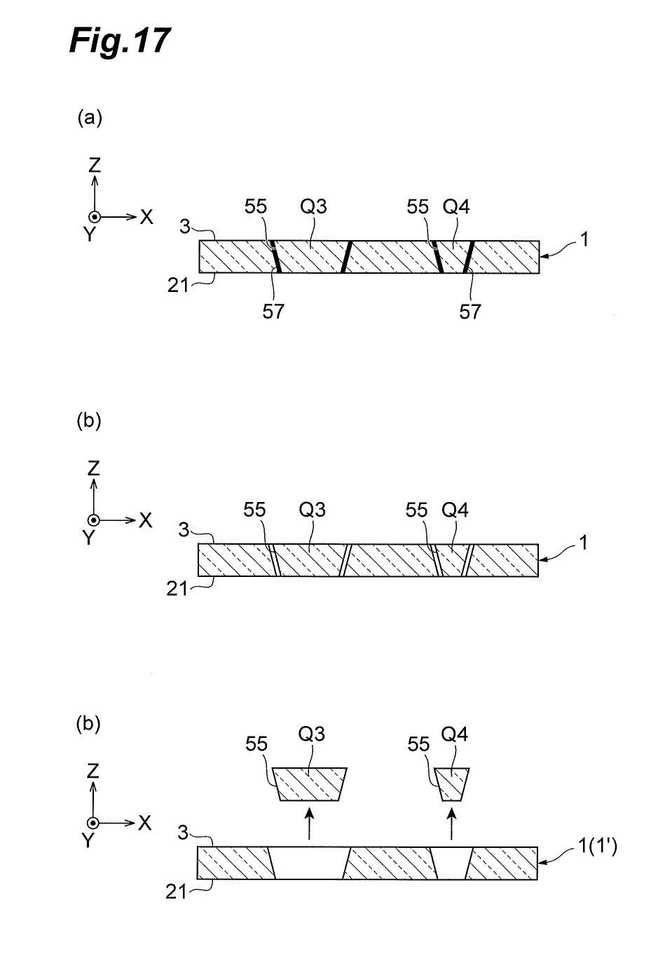

In the case where working for the object 1 is performed in the present embodiment, first, as shown in FIG. 17A, modified regions 57 are formed along the outlines of the hollowed-out portions Q3 and Q4 in the object 1 by irradiating the object 1 with the laser light L. The modified regions 57 connect to each other along the respective side surfaces of the conical trapezoid-shaped hollowed-out portions Q3 and Q4, and are further exposed on the surface 3 side and the rear surface 21 side of the object 1. The modified regions 57 are formed to be terraced so as to be tilted to the Z direction when viewed from the Y direction (X direction).

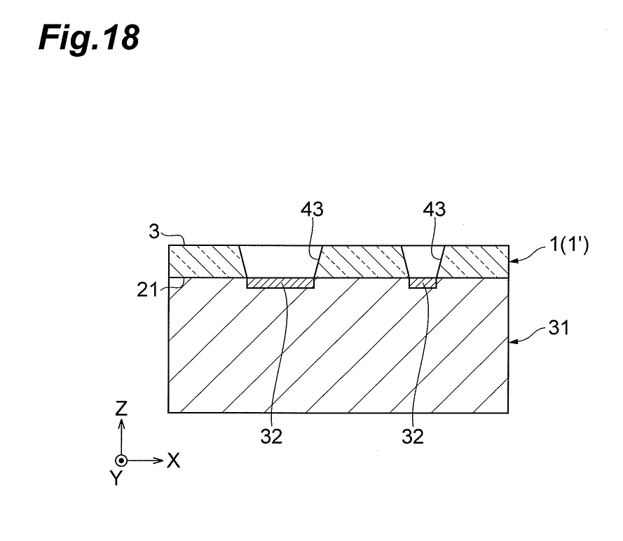

Next, after performing etching onto the object 1 in which the modified regions 57 are formed, to remove the modified regions 57 in the object 1 as shown in FIG. 17B, the hollowed-out portions Q3 and Q4 are moved so as to be taken out from the surface 3 side, to be removed from the object 1 as shown in FIG. 17C. Thereby, working is performed so as to hollow out the hollowed-out portions Q3 and Q4 in the object 1, thereby forming through-holes 43 in the object 1 as shown in FIG. 18. Then, the object 1′ after working is laminated on the device substrate 31 so as to locate the through-holes 43 on the device 32.

As described above, in the present embodiment as well, the above-described operation and effect that improve the strength and quality of the object 1′ after working are exerted.

Further, in the present embodiment, as described above, the modified regions 57 tilted to the Z direction when viewed from the Y direction are formed in the object 1, to hollow out the hollowed-out portions Q3 and Q4 having taper portions 55. Therefore, the following operation and effect are exerted. That is, it is easy to move the hollowed-out portions Q3 and Q4 so as to take out those from the surface 3 side, which makes it possible to easily remove the hollowed-out portions Q3 and Q4 from the object 1. Moreover, when the object 1′ is laminated on the device substrate 31 after working (refer to FIG. 18), the corners thereof are to be chamfered. Therefore, it is possible to prevent the object 1′ from being chipped due to impact.

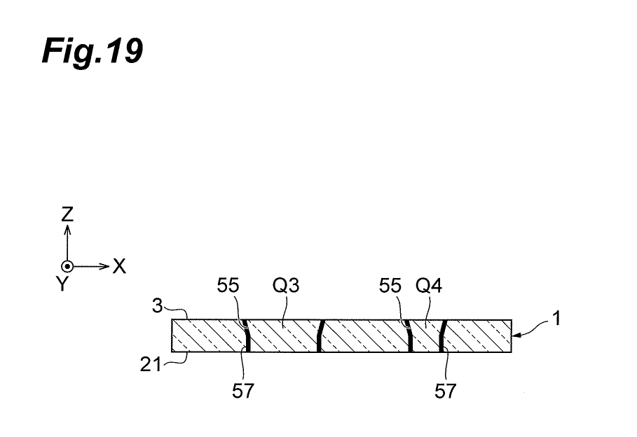

In addition, in the present embodiment, as shown in FIG. 19, the modified regions 57 may be formed so as to tilt only some portions on the surface 3 side and to make the other portions be along the Z direction in side view, to perform working so as to hollow out the hollowed-out portions Q3 and Q4 in which the taper portions 55 are formed only on the surface 3 side. That is, it suffices that the hollowed-out portions Q3 and Q4 have the taper portions 55 tilted to the Z direction.

### Third Embodiment

Next, a third embodiment of the present invention will be described. In addition, in the description of the present embodiment, points different from the first embodiment will be mainly described.

In the present embodiment, working is performed so as to hollow out a plurality of hollowed-out portions Q5 and Q6 in the object 1. The hollowed-out portion Q5 includes a hollowed-out portion Q5a on the surface 3 side and a hollowed-out portion Q5b on the rear surface 21 side, and the hollowed-out portion Q6 includes a hollowed-out portion Q6a on the surface 3 side and a hollowed-out portion Q6b on the rear surface 21 side.

The hollowed-out portions Q5a and Q6a are conical trapezoid-shaped with the surface 3 serving as the bottom surface. Further, the hollowed-out portions Q5a and Q6a have taper portions 71 tilted to the Z direction so as to widen toward the surface 3 side of the object 1, on their side surfaces. On the other hand, the hollowed-out portions Q5b and Q6b are conical trapezoid-shaped with the rear surface 21 serving as the bottom surface. Further, the hollowed-out portions Q5b and Q6b have taper portions 72 tilted to the Z direction so as to widen toward the rear surface 21 side of the object 1, on their side surfaces.

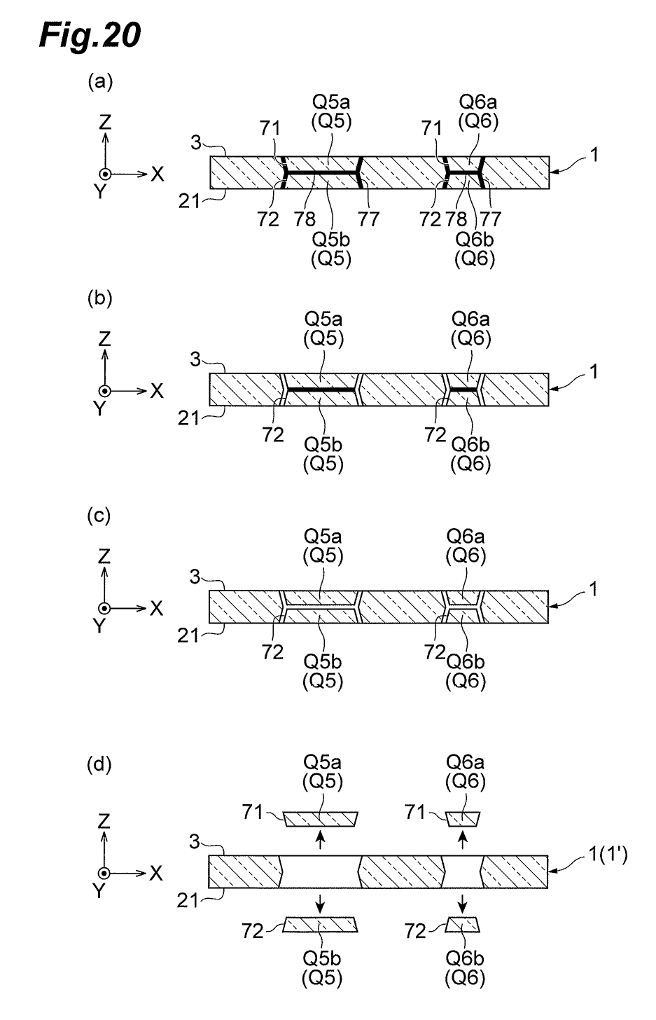

In the case where working for the object 1 is performed in the present embodiment, first, as shown in FIG. 20A, modified regions 77 are formed along the outlines of the hollowed-out portions Q5 and Q6 in the object 1 by irradiating the object 1 with the laser light L. In addition thereto, modified regions 78 are formed along the X-Y plane between the hollowed-out portions Q5a and Q5b in the hollowed-out portion Q5, and the modified regions 78 are formed along the X-Y plane between the hollowed-out portions Q6a and Q6b in the hollowed-out portion Q6.

The modified regions 77 connect to each other along the respective side surfaces of the conical trapezoid-shaped hollowed-out portions Q5 and Q6, and are further exposed on the surface 3 side and the rear surface 21 side of the object 1. The modified regions 77 extend so as to be inflected when viewed from the Y direction (X direction). The modified region 78 extends along the X-Y plane so as to define the hollowed-out portions Q5a and Q5b at the middle position in the Z direction of the modified region 77, to connect to the modified region 77. The modified region 78 is formed linearly along the X direction (Y direction) when viewed from the Y direction (X direction), and formed to be circular when viewed from the Z direction.

Next, after performing etching onto the object 1 to remove the modified regions 77 in the object 1 as shown in FIG. 20B, the modified regions 78 in the object 1 are removed as shown in FIG. 20C. Next, as shown in FIG. 20D, the hollowed-out portions Q5a and Q6a are moved so as to be taken out from the surface 3 side, to be removed from the object 1, and the hollowed-out portions Q5b and Q6b are moved so as to be taken out from the rear surface 21 side, to be removed from the object 1.

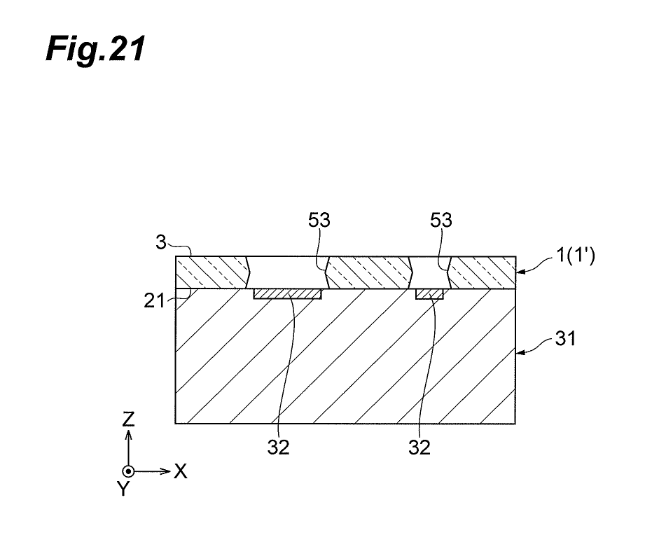

Thereby, working is performed so as to hollow out the hollowed-out portions Q5 and Q6 in the object 1, thereby forming through-holes 53 in the object 1 as shown in FIG. 21. Then, the object 1′ after working is laminated on the device substrate 31 so as to locate the through-holes 53 on the device 32.

As described above, in the present embodiment as well, the above-described operation and effect that improve the strength and quality of the object 1′ after working are exerted.

Further, in the present embodiment, as described above, the modified regions 77 extending so as to be inflected when viewed from Y direction are formed in the object 1, to hollow out the hollowed-out portions Q5 and Q6 having taper portions 71 and 72. Therefore, the following operation and effect are exerted. That is, it is easy to move the hollowed-out portions Q5a and Q6a so as to take out those from the surface 3 side, and it is also easy to move the hollowed-out portions Q5b and Q6b so as to take out those from the rear surface 21 side, which makes it possible to easily remove the hollowed-out portions Q5 and Q6 from the object 1. Moreover, when the object 1′ is laminated on the device substrate 31 after working (refer to FIG. 21), the corners thereof are to be chamfered. Therefore, it is possible to prevent the object 1′ from being chipped due to impact.

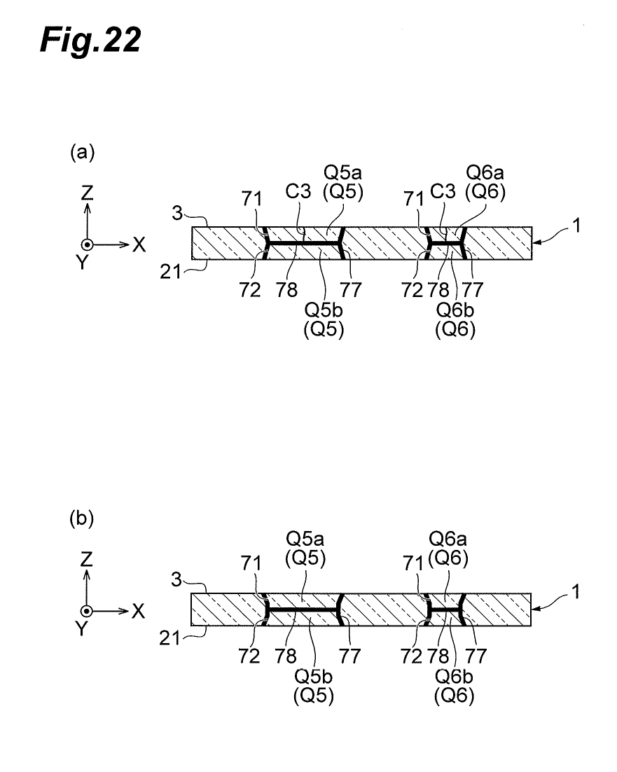

In addition, in the present embodiment, as shown in FIG. 22A, the modified regions 78 may be formed so as to generate a fracture C3 from the modified regions 78 to the surface 3. In this case, the etchant is infiltrated into the inside through the fracture C3, so as to be able to facilitate and speed up the advance of etching along the modified regions 78. Incidentally, in this case, in place of the fracture C3 from the modified regions 78 to the surface 3, the fracture from the modified regions 78 to the rear surface 21 may be generated.

Further, as shown in FIG. 22B, the modified regions 77 in the present embodiment may be formed so as to tilt some portions thereof on the surface 3 side and the rear surface 21 side and to make the portions between some portions be along the Z direction when viewed from the Y direction (X direction). In other words, it suffices that the hollowed-out portions Q5a and Q6a have the taper portions 71 on some portions on the surface 3 side, and the hollowed-out portions Q5b and Q6b have the taper portions 72 on some portions on the rear surface 21 side.

The preferred embodiments of the present invention have been described above. However, the laser processing method according to the present invention is not limited to the above-described embodiments, and may be modified within the scope of the gist disclosed in the respective claims, or may be applied to another embodiment.

For example, a laser light incidence plane at the time of forming modified regions is not limited to the surface 3 of the object 1, and may be the rear surface 21 of the object 1. Further, in the above-described embodiments, working is performed so as to hollow out the two hollowed-out portions at the same time. However, the number of hollowed-out portions may be one or three, or more.

Further, the above-described embodiments are working for forming through-holes in the object. However, the above-described embodiments are not limited thereto, and may be working for outline working of the object. That is, hollowed-out portions (predetermined portions) may be manufactured products.

Further, in the above-described embodiments, the modified regions themselves are connected to one another along the outlines of the hollowed-out portions. However, it suffices that the fracture which is contained in the modified regions 7 or extend from the modified regions may be connected along the outlines of the hollowed-out portions.

Further, ON and OFF irradiation with the laser light L in the above-described embodiment may be performed by, not only controlling emission with the laser light L to be ON and OFF, but also opening and closing a shutter provided on the optical path of the laser light L, masking the surface 3 of the object 1, or the like. Moreover, an intensity of the laser light L may be controlled between an intensity which is higher than or equal to a threshold value (working threshold value) at which the modified regions are formed and an intensity which is lower than or equal to the working threshold value.

Further, in the present invention, in some cases, modified regions may be formed along the outlines of the hollowed-out portions by repeatedly performing the process of irradiation with the laser light L while moving the converging point in the X direction and the Y direction along the part to form a modified region so as to focus a converging point on a predetermined Z directional position, while changing the Z directional position for the converging point.

### INDUSTRIAL APPLICABILITY

In accordance with the present invention, it is possible to improve strength and quality of a processed object to be processed.

### DESCRIPTION OF SYMBOLS

1: Object, 3: Surface (one surface, outer surface), 7, 57, 77:

Modified regions (first modified regions, second modified regions), 21: Rear surface (one surface, outer surface), 55, 71, 72: Taper portions, 78: Modified regions, C1 to C3: fracture, L: laser light, P: Converging point, Q1 to Q6: Hollowed-out portions (predetermined portions).

1. A laser processing method for working an object to be processed so as to hollow out a predetermined portion of the object by utilizing a modified region which is formed by converging a laser light inside the object, the method comprising:
a laser light irradiating step of irradiating the object with the laser light, to form the modified region along an outline of the predetermined portion in the object;
an etching step of performing etching onto the object after the laser light irradiating step, to selectively advance etching along a fracture which is contained in the modified region or extend from the modified region; and
a spacing and moving step of spacing and moving the predetermined portion from the object after the etching step, wherein
in the laser light irradiating step, the modified region is formed so that the fracture is connected along the outline, and the fracture is exposed on an outer surface side of the object.

2. The laser processing method according to claim 1, wherein, in the laser light irradiating step, a first modified region is formed at a first depth position in a direction of irradiation with the laser light in the object, and thereafter, a second modified region is formed at a second depth position on a laser light irradiation surface side from the first depth position in the object.

3. The laser processing method according to claim 1, wherein the laser light irradiating step includes
a first step of repeatedly performing the process of irradiating with the laser light while relatively moving a converging point of the laser light along one direction perpendicular to the direction of irradiation with the laser light, so as to change a depth position of the converging point in the direction of irradiation, and
a second step of repeatedly performing the first process so as to change a position of the converging point in the other direction perpendicular to the direction of irradiation and the one direction.

4. The laser processing method according to claim 1, wherein a shape of the outline of the predetermined portion has a taper portion tilted to a direction perpendicular to one surface of the object so as to widen toward the one surface side.

5. The laser processing method according to claim 2, wherein the laser light irradiating step includes
a first step of repeatedly performing the process of irradiating with the laser light while relatively moving a converging point of the laser light along one direction perpendicular to the direction of irradiation with the laser light, so as to change a depth position of the converging point in the direction of irradiation, and
a second step of repeatedly performing the first process so as to change a position of the converging point in the other direction perpendicular to the direction of irradiation and the one direction.

6. The laser processing method according to claim 2, wherein a shape of the outline of the predetermined portion has a taper portion tilted to a direction perpendicular to one surface of the object so as to widen toward the one surface side.

7. The laser processing method according to claim 3, wherein a shape of the outline of the predetermined portion has a taper portion tilted to a direction perpendicular to one surface of the object so as to widen toward the one surface side.

8. The laser processing method according to claim 5, wherein a shape of the outline of the predetermined portion has a taper portion tilted to a direction perpendicular to one surface of the object so as to widen toward the one surface side.
